(19) United States
(12) Patent Application Publication
(10) Pub. No.: US 2023/0114796 A1
(43) Pub. Date: Apr. 13, 2023

(54) Method for operating a first and a second food machine, storage device, and food machine

(71) Applicant: GEA Food Solotions Germany GmbH, Biedenkopf-Wallau (DE)

(72) Inventors: Erdal Cilingir, Bad Laasphe (DE); Peter De Hoog, LC Herten (NL); Stefan Maidel, Kempten (DE); Dennis Theele, ZL Horst (NL); Jochen Rehn, Biedenkopf-Wallau (DE); Nelson Da Costa Moreira, Biedenkopf (DE)

(21) Appl. No.: 17/915,157

(22) PCT Filed: Mar. 30, 2021
(86) PCT No.: PCT/EP2021/058334

§ 371 Date: Sep. 28, 2022

(30) Foreign Application Priority Data
Apr. 1, 2020 (DE) 10 2020 204 258.6
Sep. 7, 2020 (DE) 10 2020 208 618.4

(51) Int. Cl. G05B 19/04; B26D 5/00; B65B 65/00; B65B 25/00

(52) U.S. Cl. CPC G05B 19/0405; B26D 5/00; B65B 65/003; B65B 25/001; B26D 11/00

(57) ABSTRACT

A method for operating a first food machine and a second food machine, where a data set required to operate the first food machine is stored in a first storage unit of the first food machine, and the data set required to operate the first food machine is additionally stored in a second storage unit of the second food machine.

### CROSS-REFERENCE TO RELATED APPLICATIONS

This application is a US National Phase of PCT/EP2021/058334 filed on Mar. 30, 2021 and which claims priority to DE 10 2020 204 258.6 filed on Apr. 1, 2020 and to DE 10 2020 208 618.4 filed on Jul. 9, 2020, all of which are hereby incorporated by reference herein for all purposes.

### FIELD

These teachings relate to a method for operating a first food machine, in particular a food processing machine or a food packaging machine, and a second food machine, in particular a food processing machine or a food packaging machine; a storage device for a food machine, in particular a food processing machine or a food packaging machine; a food machine, in particular a food processing machine or a food packaging machine, including a storage device, and a production line including a first food machine, in particular a food processing machine or a food packaging machine, and a second food machine, in particular a food processing machine or a food packaging machine.

### BACKGROUND

Food machines, such as food processing machines, in particular slicing machines or slicers, or food packaging machines, in particular form-fill-seal packaging machines, are typically configurable in a variety of ways, for example to allow the manufacture of different food products and/or different packages or the packaging of the food products in different packages using the same machine. The configuration of these food machines is typically stored in a data set that is stored in a storage device of each food machine. It is often provided that the data set can be changed by an operator of the machine, for example to adapt the configuration to changes in the production or to change the production to another product.

In the event of certain error states, data may be lost in the storage device of the food machine. In such a case, the food machine usually has to be configured in a relatively complex manner, possibly even manually, to allow production to be resumed with the food machine.

### SUMMARY

The object of the present invention is to increase the availability of a food machine or a production line comprising a plurality of food machines.

To achieve the object, in accordance with the invention, a method for operating a first food machine, in particular a food processing machine or a food packaging machine, and a second food machine, in particular a food processing machine or a food packaging machine, is proposed,
wherein a data set required to operate the first food machine is stored in a first storage unit of the first food machine, and
wherein the data set required to operate the first food machine is additionally stored in a second storage unit of the second food machine.

By storing the data set required to operate the first food machine both in the first storage unit and also in the second storage unit according to the invention, the recovery of the data set after a data loss in the first storage unit can be facilitated. Such a recovery can be accomplished by transmitting a copy of the data set from the second storage unit into the first storage unit. In this way, the first food machine, and thus also the production line of which the first food machine is a part, can be reactivated more quickly, thereby increasing the availability of the food machine or the production line.

According to an advantageous embodiment of the invention, it is provided that the required data set of the first food machine is not required to operate the second food machine, for example if the first food machine and the second food machine are not identical or not of the same type. This can be the case if the first food machine is a slicing machine or a slicer and the second food machine is a form-fill-seal packaging machine. Alternatively, it can be provided that the first food machine and the second food machine are of the same type but perform different process steps. This can be the case if the first and second food machines are form-fill-seal packaging machines. In this case, the data set required to operate the first food machine is uniquely assigned to the first food machine.

According to an advantageous embodiment of the invention, it is provided that the data set is transmitted to the second storage unit of the second food machine via a wireless or wired communication link. Preferably, the data set is transmitted from the first food machine to the second food machine. Alternatively, it can be provided that the data set is transmitted from a production line control device to the second storage unit of the second food machine and preferably also to the first storage unit of the first food machine.

An advantageous embodiment of the invention provides that the data set for operating the first food machine comprises configuration data for operating the first food machine and/or input data and/or user data. Configuration data describe the specific configuration of the food machine, for example the type of stations, sequence of stations, or number of stations, for example cutting stations such as longitudinal or transverse cutting stations, or also details of stations, such as the cutting stroke. Input data are detected with an input device of the first food machine. These input data can be parameters of or relating to the food machine, such as characteristics of the food machine specifiable by an operator. Such parameters can be, for example, time specifications for activating and/or deactivating elements of the food machine, specifications for the activation state of functions or elements of the food machine, or other settable physical variables and/or setpoints of control loops. Input data can be, for example, dimensions of packages or order data, such as order number, batch number, number of packages, recipe to be used, packaging films and labels to be used, user comments, and/or data for information only. In particular, the data set required to operate the first food machine within the meaning of the invention does not include any measured values that are used to control the packaging machine. However, the data set required to operate the first food machine can comprise measured values that can be used to generate information that can be presented to a user of the food machine. Such information that can be presented to the user can be, for example, statistical information and/or reference information and/or deviations from a reference value or reference curve that arise during operation of the food machine.

The food machine operator can be a laborer, a shift supervisor, and/or a maintenance worker.

According to an advantageous embodiment of the invention, it is provided that the data set for operating the first food machine comprises user data. The user data can comprise, for example, user-dependent authorization data and/or user-dependent machine settings, for example user-dependent display settings.

A preferred embodiment is one in which a loss of the data set in the first storage unit of the first food machine is recognized and the data set is transmitted from the second storage unit of the second food machine into the first storage unit. By transmitting the data set into the first storage unit, the loss of the data can be compensated and the first food machine can be restored to a functional state.

It is particularly preferred if a loss of input data or user data of the data set is recognized in the first storage unit of the first food machine is recognized and the input data or user data of the data set are transmitted from the second storage unit of the second food machine into the first storage unit. According to such an embodiment, a partial loss of data of the data set, i.e. of input data or user data, can be compensated by a partial replay of the data set, i.e. only of the input data or user data or even only of a part thereof, such as the lost part.

An embodiment of the method in which a loss of the data set in the first storage unit of the first food machine is recognized and the first food machine is controlled by a control device of the second food machine with the aid of the data set stored in the second storage unit has proven to be advantageous. In such an embodiment, the control unit of the second food machine takes over the control of the first food machine. This takeover can be temporary, for example until the data set required for operation is restored in the first storage device of the first food machine. Alternatively, the second food machine can permanently take over the control of the first food machine.

In an advantageous embodiment of the invention, the data set for operating the first food machine comprises order data for a first order transmitted from an order data management system via a wireless or wired communication link. The order data can contain data relating to products to be produced in accordance with the order and/or serial numbers and/or batch information.

According to a preferred embodiment, when order data for a second order are not provided by the order data management system, order data for the first order are transmitted from the second storage unit of the second food machine into the first storage unit. By transmitting the data set into the first storage unit, the loss of the data can be compensated based on the data of a previous order, and the first food machine can be set into an operable state. In so doing, it may be necessary to manually adapt some data, such as serial numbers and/or batch information.

According to an advantageous embodiment, it is provided that the first food machine and the second food machine are part of a common production line of a plurality of food machines comprising a third food machine, wherein a further data set required to operate the second food machine is stored in the second storage unit of the second food machine, and wherein the further data set required to operate the second food machine is additionally stored in a third storage unit of the third food machine. As a result of this linking of, in each case, two different food machines for storing a copy of the particular relevant data set, a chain is formed. In the event of a failure of the first food machine, a copy of the data set required for the first food machine can be transmitted from the second food machine. At the same time, the second food machine is backed up by a copy of its data set stored in another food machine. Therefore, a loss of the data set in the first storage unit of the first food machine has no negative influence on the second food machine.

An advantageous embodiment provides that the first food machine and the second food machine are part of a common production line of a plurality of food machines, wherein, in particular, all data sets required to operate the production line formed of a plurality of food machines are stored in the first storage unit of the first food machine and in the second storage unit of the second food machine. The fact that a plurality of, in particular all data sets are stored in the first and the second storage unit means that, if one of the data sets is lost, either the first storage unit or the second storage unit can be used selectively to transmit the particular data set to the corresponding food machine.

According to an advantageous embodiment it is provided that the first food machine and the second food machine are part of a common production line of a plurality of food machines comprising a third food machine, wherein a data set required to operate the first food machine is stored in the first storage unit of the first food machine, and wherein the data set required to operate the first food machine is additionally stored in a second storage unit of the second food machine, wherein a further data set required to operate the second food machine is stored in the second storage unit of the second food machine, and wherein the further data set required to operate the second food machine is additionally stored in a third storage unit of the third food machine, wherein an additional data set required to operate the third food machine is stored in the third storage unit of the third food machine, and wherein the additional data set required to operate the third food machine is additionally stored in the first storage unit of the first food machine. As a result of this linking of three different food machines for storing in each case a copy of the particular relevant data set, a ring is formed. In the event of a failure of the first food machine, a copy of the data set required for the first food machine can be transmitted from the second food machine. At the same time, the second food machine is backed up by a copy of its data set stored in another food machine. At the same time, the third food machine is secured by a copy of its data set stored in another food machine. Therefore, a loss of the data set in the first storage unit of the first food machine has no negative influence on the second and third food machines; likewise, a loss of the data set in the second storage unit of the second food machine therefore has no negative influence on the first and third food machines; furthermore, a loss of the data set in the third storage unit of the third food machine has no negative influence on the first or second food machines.

A person skilled in the art will understand that other combinations of pairwise storage of a data set are also possible.

According to an advantageous embodiment of the invention, it is provided that the data set required to operate the first food machine is selected, wherein an indicator is detected by a detection device in order to select the data set, and the data set is determined from a list of predefined data sets by a selection unit depending on the detected indicator. The indicator can, for example, be applied to or arranged on an order document or a container.

Preferably, the indicator is an optically detectable indicator, for example a bar code or a two-dimensional code, and the detection device is an optical detection device, for example a bar code detection device or a detection device for detecting a two-dimensional code. Alternatively, the indicator can be an indicator detectable by an electromagnetic field, for example an RFID transponder, and the detection device can be a detection device for reading an indicator detectable by an electromagnetic field, for example an RFID reader.

A further subject of the invention is a storage device for a food machine, in particular a food processing machine or a food packaging machine, characterized in that the storage device is configured to receive, store and transmit to the other food machine a data set required to operate another food machine.

Another object of the invention is to provide a food machine, in particular a food processing machine or a food packaging machine, comprising a storage device as described above.

For example, the food machine can be a slicing machine, defroster, cutter, mixer, thermoforming packaging machine, vertical form fill seal machine, or horizontal form fill seal machine.

The food machine can be suitable for meat, poultry, fish/seafood, cheese, meat substitutes, protein substitutes such as from insects or fungi, farmed meat, vegetables, pizza, bread, bakery products, pastries, biscuits or the like. The food machine formed as a food processing machine, in particular a meat processing machine, can be formed as a thawing machine, a cutter machine, a mixer machine, a tumbler machine, a crusher machine, an emulsifier machine, a marinating machine, a massaging machine, a meat injector machine, a filtration machine for brine and/or meat ingredients, a cooling machine for brine, a meat press machine, a freezer machine, a thawing machine, a tenderizer machine, a shaker machine, a fat analyzer machine, a pumping machine, a crusher machine, forming or portioning machine, coating machine such as dough/breading/crumbling/cooking oil machine, dust-removing machine, drying/cooking/browning/frying steaming/sous vide machine, frying machine, grilling machine, smoking machine, frying oil filtering machine, oven/heating/cooking installation, food scanner, slicing machine, weighing machine, system for detecting foreign objects such as metal/plastic/bone, cleaning system for a food contact region, for example for injection needles, or transport system, filling/loading and/or unloading system and/or conveying system and/or dosing system. The food machine formed as a food packaging machine can be formed as a thermoforming packaging machine, vertical form fill seal machine or horizontal form fill seal machine, bottle filling machine, filling machine, labeler/printer, lollipop forming/cooling/wrapping machine, lollipop packaging machine, sugar cube forming/drying/packaging machine, or depositor. Alternatively, the food machine can be an automation/control/line control system for one or more of the aforementioned machines.

A further subject of the invention is a production line comprising a first food machine, in particular a food processing machine or a food packaging machine, and a second food machine, in particular a food processing machine or a food packaging machine, wherein a data set required to operate the first food machine is stored in a first storage unit of the first food machine, and the data set required to operate the first food machine is additionally stored in a second storage unit of the second food machine.

In the case of the storage device and the food machine, the same advantages can be achieved which have already been explained in conjunction with the method according to the invention. The advantageous embodiments and features described in conjunction with the method can also be applied to the display device and the food machine alone or in combination.

The food machine can further comprise a communication interface for receiving and/or transmitting data. The communication interface can be coupled to a wireless or a wired communication link.

Further details, features and advantages of the invention will become apparent from the drawings, as well as from the following description of preferred embodiments based on the drawings. The drawings merely illustrate exemplary embodiments of the invention, which do not limit the concept of the invention.

### BRIEF DESCRIPTION OF THE FIGURE

FIG. 1 shows a schematic illustration of a production line according to an exemplary embodiment of the invention.

### DETAILED DESCRIPTION

In the various figures, identical parts are always provided with the same reference signs and are therefore generally also named or mentioned only once in each case.

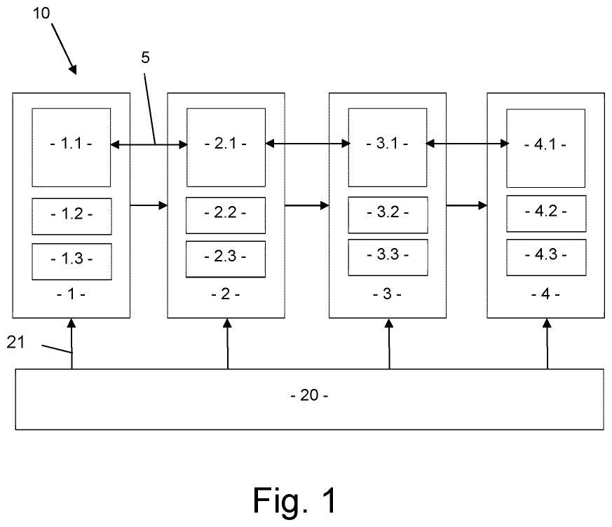

The illustration in FIG. 1 shows a schematic illustration of a production line 10 consisting of a plurality of, in this case four, food machines 1, 2, 3, 4. The production line 10, in particular the individual food machines 1, 2, 3, 4, are connected to an order data management system 20, via which the food machines 1, 2, 3, 4 can be configured for production of orders held in the order data management system 20.

The food machines 1, 2, 3, 4 each comprise a storage unit 1.1, 2.1, 3.1, 4.1, in which a data set required to operate the first food machine 1 is stored. A further component of the food machines is an operating unit 1.2, 2.2, 3.2, 4.2, via which an operator can make inputs. These inputs can be converted into input data for the operation of the relevant food machine 1, 2, 3, 4 and stored in the relevant storage unit 1.1, 2.1, 3.1, 4.1 as part of the data set. The operating unit 1.2, 2.2, 3.2, 4.2 can be formed as part of a combined operating and display unit, for example as a touch-sensitive screen. Furthermore, the food machines 1, 2, 3, 4 each comprise a control unit 1.3, 2.3, 3.3, 4.3, via which the relevant food machine 1, 2, 3, 4 is controlled. For control, the control unit 1.3, 2.3, 3.3, 4.3 reads data of the relevant data set from the storage unit 1.1, 2.1, 3.1, 4.1 of the food machine.

In the production line 10 according to the exemplary embodiment, four food machines 1, 2, 3, 4 are provided in series in a process flow in such a way that the processing starts in a first food machine 1, the products of the first food machine 1 are forwarded to a second food machine 2, the products of the second food machine 2 are forwarded to a third food machine 3, and the products of the third food machine 3 are forwarded to a fourth food machine 4. The food machines 1, 2, 3, 4 can be configured either as a food processing machine or as a food packaging machine. For example, the first food machine 1 and the second food machine 2 and the third food machine 3 can be formed as food processing machines and the fourth food machine 4, which follows the first three food machines 1, 2, 3 in the process flow, can be formed as a food packaging machine.

In order to allow the greatest possible availability of the production line 10, special measures are taken in the production line 10 according to the exemplary embodiment. A data set required to operate the first food machine 1 is stored both in a first storage unit 1.1 of the first food machine 1 and also in a second storage unit 2.1 of the second food machine 2. This makes it easier to restore the data set after a loss of data in the first storage unit 1.1 and thus increases the availability of the production line 10.

For example, an operator of the first food machine 1 can generate input data for operating the first food machine 1 via the operating unit 1.2. These data are stored in the first storage unit 1.1. In order to be able to retain them in the second food machine in the event of a loss, the input data or the complete data set stored in the first storage unit 1.1 are transmitted to the second storage unit 2.1 of the second food machine 2 via a wireless or wired communication link 5. The data set can additionally comprise user data, for example user-dependent authorization data and/or user-dependent machine settings, for example user-dependent display settings.

In the production line 10 according to the exemplary embodiment, with regard to the storage units 1.1, 2.1, 3.1, 4.1, pairs of food machines 1, 2, 3, 4 are formed which are interleaved with each other in a chain. That is to say, the second storage unit 2.1 stores the data set required to operate the first food machine 1, and the third storage unit 3.1 of the third food machine 3 stores the data set required to operate the second food machine 2. The fourth storage unit 4.1 of the fourth food machine 4 stores the data set required to operate the third food machine 3.

According to a variation of the exemplary embodiment, it can be provided that all data sets required to operate the production line 10 for the individual food machines 1, 2, 3, 4 are stored both in the first storage unit 1.1 of the first food machine 1 and in the second storage unit 2.1 of the second food machine 2. Preferably, this totality of data sets is also stored in the third storage unit 3.1 and in the fourth storage unit 4.1, particularly preferably in the storage units of all food machines 1, 2, 3, 4 of the production line 10.

The food machines 1, 2, 3, 4, in particular the respective control units 1.3, 2.3, 3.3, 4.3 of the food machines 1, 2, 3, 4, are configured to recognize an error state of the corresponding food machine 1, 2, 3, 4, in particular of the storage unit 1.1, 2.1, 3.1, 4.1 of the food machine 1, 2, 3, 4. Furthermore, the control units 1.3, 2.3, 3.3, 4.3 are arranged to restore the data set from the copy in a storage unit 1.1, 2.1, 3.1, 4.1 of another food machine 1, 2, 3, 4 in the event of a recognized error and/or a recognized loss of the data set in the relevant storage unit 1.1, 2.1, 3.1, 4.1. For example, an error and/or a recognized loss of the data set in the first storage unit 1.1 of the first food machine 1 can be recognized and the data set can be transmitted from the second storage unit 2.1 of the second food machine 2 to the first storage unit 1.1 of the first food machine 1.

When transmitting data from the second into the first storage unit 1.1, the complete data set can be transmitted. Alternatively, it is possible to transmit only those data from the second storage unit 2.1 into the first storage unit 1.1 for which the loss has been recognized. For example, a loss of input data or user data of the data set can be recognized in the first storage unit 1.1 of the first food machine 1 and the input data or user data of the data set can be transmitted from the second storage unit 2.1 of the second food machine 2 into the first storage unit 1.1.

In addition, it can be provided that in the event that a loss of the data set in the first storage unit 1.1 of the first food machine 1 is recognized, the first food machine 1 is controlled by the second control device 2.3 of the second food machine 2 with the aid of the data set stored in the second storage unit 2.1. The first food machine 1 can be controlled by the second control unit temporarily, for example until the data set in the first storage unit 1.1 is restored and/or the first food machine is fully functional again.

Once the data set for the operation of the first food machine 1 is restored in the first storage unit, the first food machine 1 can be controlled by means of the data set and the first control unit 1.3.

The data set for operating the first food machine 1 can comprise order data for a first order, which are transmitted by the order data management system 20 via a wireless or wired communication link 21. It is conceivable that—for example, after transmission of the first order—there is a failure of the order data management system 20, or the communication link 21 to the order data management system 20 is defective. In such a case, i.e. when order data for a second order are not provided by the order data management system 20, order data for the first order are transmitted from the second storage unit 2.1 of the second food machine 2 to the first storage unit 1.1. Any missing order data for the second order, for example serial numbers and/or batch information, are then manually adapted, for example by an operator input at the first control unit 1.2 of the first food machine 1.

### LIST OF REFERENCE SIGNS

1 food machine

1.1 storage unit

2 food machine

2.1 storage unit

3 food machine

3.1 storage unit

4 food machine

4.1 storage unit

5 communication link

10 production line

20 order data management system

1. A method for operating a first food machine and a second food machine,
wherein a data set required to operate the first food machine is stored in a first storage unit of the first food machine, and
wherein the data set required to operate the first food machine is additionally stored in a second storage unit of the second food machine.

2. The method as claimed in claim 1, wherein the data set required to operate the first food machine is not required to operate the second food machine.

3. The method as claimed in claim 1, wherein the data set required to operate the first food machine is transmitted to the second storage unit of the second food machine via a wireless or wired communication link.

4. The method as claimed in claim 1, wherein the data set required to operate the first food machine comprises input data detected with an input device of the first food machine.

5. The method as claimed in claim 1, wherein the data set required to operate the first food machine comprises user data.

6. The method as claimed in claim 1, wherein when a loss of the data set in the first storage unit of the first food machine is recognized, the data set is transmitted from the second storage unit of the second food machine into the first storage unit of the first food machine.

7. The method as claimed in claim 1, wherein when a loss of input data or user data of the data set in the first storage unit of the first food machine is recognized, the input data or the user data of the data set are transmitted from the second storage unit of the second food machine into the first storage unit of the first food machine.

8. The method as claimed in claim 1, wherein when a loss of the data set in the first storage unit of the first food machine is recognized, the first food machine is controlled by a control device of the second food machine with aid of the data set stored in the second storage unit of the second food machine.

9. The method as claimed in claim 1, wherein the data set to operate the first food machine comprises order data for a first order that is transmitted from an order data management system via a wireless or wired communication link.

10. The method as claimed in claim 9, wherein when order data for a second order is not provided by the order data management system, the order data from the first order is transmitted from the second storage unit of the second food machine into the first storage unit of the first food machine.

11. The method as claimed in claim 1, wherein the first food machine and the second food machine are part of a common production line of a plurality of food machines comprising a third food machine,
wherein a further data set required to operate the second food machine is stored in the second storage unit of the second food machine, and
wherein the further data set required to operate the second food machine is additionally stored in a third storage unit of the third food machine.

12. The method as claimed in claim 1, wherein the first food machine and the second food machine are part of a common production line of a plurality of food machines,
wherein all data sets required to operate the production line of the plurality of food machines are stored in the first storage unit of the first food machine and in the second storage unit of the second food machine.

13. The method as claimed in claim 1, wherein the first food machine and the second food machine are part of a common production line of a plurality of food machines comprising a third food machine,
wherein a further data set required to operate the second food machine is stored in the second storage unit of the second food machine, and
wherein the further data set required to operate the second food machine is additionally stored in a third storage unit of the third food machine,
wherein an additional data set required to operate the third food machine is stored in the third storage unit of the third food machine, and
wherein the additional data set required to operate the third food machine is additionally stored in the first storage unit of the first food machine.

14. The method as claimed in claim 1, wherein the data set required to operate the first food machine is selected, wherein an indicator is detected by a detection device in order to select the data set, and the data set is determined from a list of predefined data sets by a selection unit depending on the detected indicator.

15. The method as claimed in claim 14, wherein the detected indicator is an optically detectable indicator and the detection device is an optical detection device.

16. A storage device for a food machine, wherein the storage device is configured to receive, store, and transmit to one or more other food machines a data set required to operate the one or more other food machines.

17. The food machine, a food processing machine, or a food packaging machine, comprising the storage device as claimed in claim 16.

18. A production line comprising a first food machine and a second food machine,
wherein a data set required to operate the first food machine is stored in a first storage unit of the first food machine, and
the data set required to operate the first food machine is additionally stored in a second storage unit of the second food machine.
